(19) United States
(12) Patent Application Publication
(10) Pub. No.: US 2011/0186695 A1
(43) Pub. Date: Aug. 4, 2011

(54) COMMUNICATION CABLE BULKHEAD ASSEMBLY

(76) Inventor: William Bourgeois, San Diego, CA (US)

(21) Appl. No.: 12/958,281

(22) Filed: Dec. 1, 2010

Related U.S. Application Data
(60) Provisional application No. 61/267,781, filed on Dec. 8, 2009.

(51) Int. Cl. F16L 3/12

(52) U.S. Cl. 248/73

(57) ABSTRACT

A cable bulkhead device is adapted to provide one or more passageways for cable to extend through a ceiling, such as through a ceiling tile or the like. The device is configured to interact with or otherwise be coupled to a ceiling tile. In normal use, the ceiling tile would be positioned on a ceiling framework among a collection of tiles.

### REFERENCE TO PRIORITY DOCUMENT

This application claims priority of co-pending U.S. Provisional Patent Application Ser. No. 61/267,781, entitled “COMMUNICATION CABLE BULKHEAD ASSEMBLY” and filed Dec. 8, 2009. Priority of the aforementioned filing date is hereby claimed and the disclosure of the Provisional Patent Application is hereby incorporated by reference in its entirety.

### BACKGROUND

The present disclosure relates to cable support devices and more particularly to a cable bulkhead device that is adapted to provide one or more passageways for cable to extend through a ceiling.

When installing electrical cable in a building, the cable is often routed above ceiling tiles so that the cables are not visible from the usable space in the building. The cable are often arranged in a collection of bundles that can have a cluttered look, which is one reason that it is desirable to position the cables above the ceiling tiles out of view of the people using the space. However, it is often necessary to pass the cable through the ceiling tiles to a location within the usable space of the building, such as to connect the cables to a device. Current systems and methods for passing cables through ceiling tiles are unwieldy and inconvenient, both in use and in aesthetics.

### SUMMARY

In view of the foregoing, there is disclosed a communication cable bulkhead assembly that is configured to provide one or more passageways for cable to extend through a ceiling tile.

In one aspect, there is disclosed a cable support device, comprising: a platform having at least one hole extending therethrough, wherein the platform is sized and shaped to be positioned atop a ceiling tile; and a tube assembly sized and shaped to be inserted through the at least one hole in the platform, wherein the tube assembly includes a main tube having a lumen and a locking member that locks the tube to the platform.

Other features and advantages should be apparent from the following description of various embodiments, which illustrate, by way of example, the principles of the disclosed devices and methods.

### BRIEF DESCRIPTION OF THE FIGURES

FIG. 1 shows a perspective view of an exemplary cable bulkhead device.

FIG. 2 shows a perspective view of a platform of the cable bulkhead device.

FIG. 3 shows a perspective view of the tube assembly of the cable bulkhead device.

### DETAILED DESCRIPTION

Before the present subject matter is further described, it is to be understood that this subject matter described herein is not limited to particular embodiments described, as such may of course vary. It is also to be understood that the terminology used here in is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

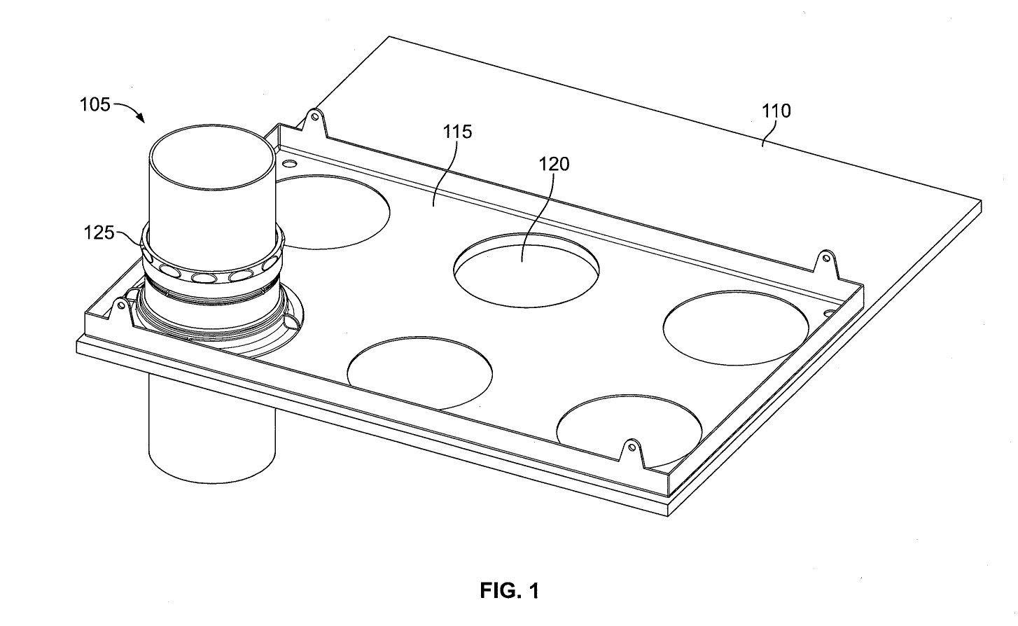

FIG. 1 shows a perspective view of a cable bulkhead device 105 that is adapted to provide one or more passageways for cable to extend through a ceiling, such as through a ceiling tile or the like. In this regard, the device 105 is configured to interact with or otherwise be coupled to a ceiling tile 110. In normal use, the ceiling tile would be positioned on a ceiling framework among a collection of tiles. For clarity of illustration, only a single ceiling tile 110 is shown. The device 105 is configured to interact with cable that extends vertically or horizontally through a ceiling tile. Although the ceiling tile 110 is shown as being rectangular, it should be appreciated that the ceiling tile can have a variety of shapes and sizes. The type of cable may vary. For example, the cable may be transmission cable (such as twisted pairs, fiber optic or innerduct), electrical wiring and the like (generally referred to in the trade as “cable” or “cabling”). In an embodiment, the device 105 may be used with cable generally known in the trade as “category 5 cable” or CAT5 cable. In other embodiment, the cable is CAT5, CAT6, audio, alarm, video, fiber, and/or any low voltage cable.

The device 105 includes a platform 115 having one or more holes 120 extending therethrough. The platform 115 is configured to be positioned adjacent the ceiling tile, such as in a juxtaposed relationship. The device 105 further includes a tube assembly 125 sized and shaped to fit at least partially through one of the holes 120. FIG. 1 shows the device 105 with a single tube assembly 125 positioned in one of the holes 120 although it should be appreciated that the device 105 can include multiple tube assemblies 125 that are each positioned in a respective hole 120.

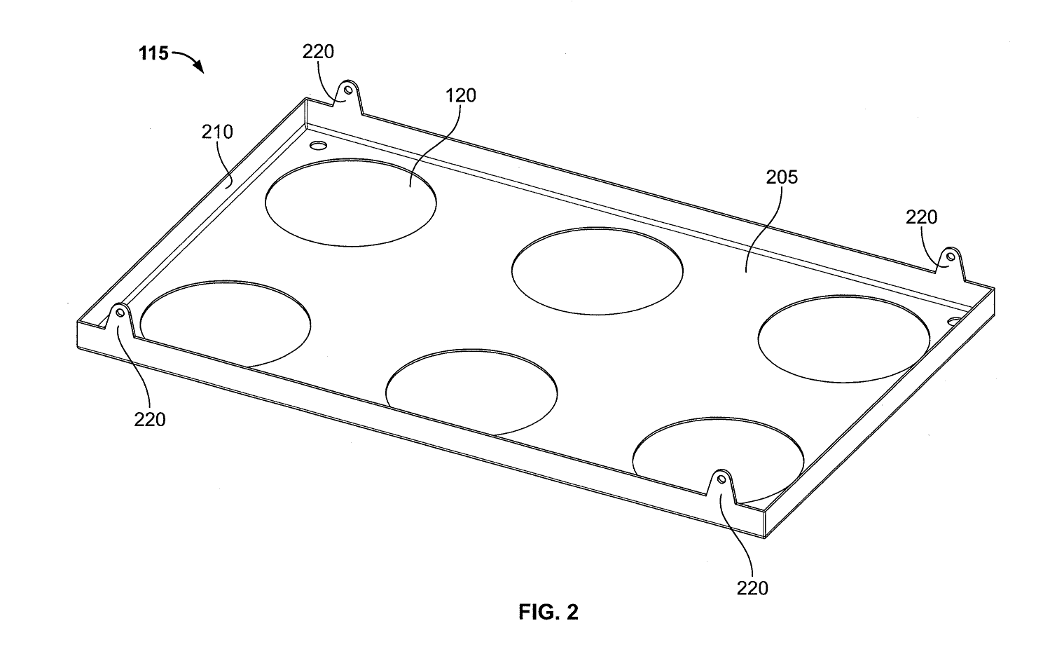

FIG. 2 shows a perspective view of an exemplary embodiment of the platform 115, which has a generally rectangular shape with a flat base 205 through which the holes 120 extend. The flat base 205 is adapted to be positioned atop a ceiling tile 110 (FIG. 1) such that the ceiling tile 110 can support the platform 115. The size and shape of the platform 115 can vary to accommodate various sizes and shapes of ceiling tiles. In addition, the base 205 can be contoured or non-flat to accommodate ceiling tiles that are not flat. In the embodiment of FIG. 1, the device includes six holes 120 that are arranged in a grid-like pattern. The quantity of holes can vary and the size, shape and spatial arrangement of the holes 120 can also vary.

With reference still to FIG. 2, the platform 115 includes an upwardly-extending flange 210 that extends around the periphery of the base 205. The flange 210 can be continuous around the entire perimeter or it can be an intermittent flange. The flange 210 defines the outer perimeter of the platform 115 and includes one or more tabs 220, each having a hole extending therethrough. Each of the tabs 220 and corresponding holes serves as a means of coupling the platform 115 to ceiling grid wire. The grid wire, where present, can be inserted through the holes in the tabs 220 such that the grid wire can assist in supporting the platform 115 on the ceiling tile.

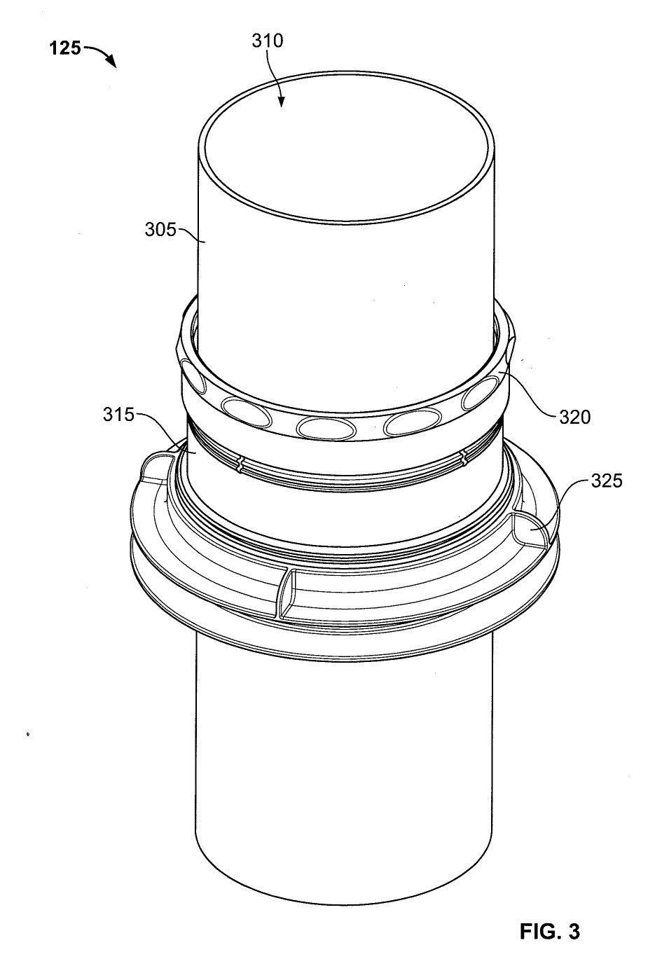

FIG. 3 shows a perspective view of the tube assembly 125 of the cable bulkhead device. The tube assembly 125 includes a tube 305 having an internal lumen 310 through which cable can be passed. The tube 305 is surrounded by a lock assembly that can be used to lock and/or immobilize the tube 305 to the platform 115, as shown in FIG. 1. In this regard, the lock assembly is configured to be inserted into one of the holes 120 in the platform 115 with the tube 305 positioned inside the lock assembly. The lock assembly locks to both the platform 115 and the tube 305 to thereby lock the tube 305 to the platform 115.

The configuration of the lock assembly can vary. In the illustrated embodiment, the lock assembly includes an outer tube 315 that fits over the tube 305, a cap 320 that fits on top of the outer tube 315, and a lock nut 325 that threadedly engages threads on the outer tube 315. The lock nut 325 can be tightened onto the outer tube 315 while the tube 305 is positioned inside the outer tube 315 and while the entire tube assembly 125 is positioned within one of the holes 120 of the platform 115. A portion of the tube assembly 125 can also lockingly engage the platform 115 (such as using a threaded engagement) to lock the tube assembly 125 to the platform.

In use, the entire device 105 is positioned on top of a portion of a ceiling, such as on top of a ceiling tile 110 as shown in FIG. 1. The ceiling tile 110 supports the device 105. As mentioned, grid wires can also be inserted through the tabs on the platform 115 to assist in supporting the weight of the device. The ceiling tile 110 desirably includes one or more holes that are aligned with the holes 120 in the platform 115. This permits the tube assembly 125 to be inserted through the holes such that the tube 305 provides a passageway for the cable to pass through the ceiling tile 110.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and endoscope of the appended claims should not be limited to the description of the embodiments contained herein.

What is claimed:

1. A cable support device, comprising:
a platform having at least one hole extending therethrough, wherein the platform is sized and shaped to be positioned atop a ceiling tile;
a tube assembly sized and shaped to be inserted through the at least one hole in the platform, wherein the tube assembly includes a main tube having a lumen and a locking member that locks the tube to the platform.

2. A device as in claim 1, wherein the platform includes an outer flange that extends around the periphery of the platform, and wherein at least one tab is positioned on the flange, the tab configured to be coupled to grid wire.

3. A device as in claim 1, wherein the locking member includes an outer tube that receives the main tube and a locking nut that can be threaded onto the outer tube to lock the outer tube to the main tube.

4. A device as in claim 3, wherein the locking nut can also be threaded onto the platform.
